(19) United States
(12) Patent Application Publication
(10) Pub. No.: US 2016/0125395 A1
(43) Pub. Date: May 5, 2016

(54) SYSTEM AND METHOD FOR FACILITATING TRANSACTIONS

(71) Applicant: EINNOVATIONS HOLDINGS PTE. LTD., Singapore (SG)

(72) Inventors: Orlando Vea, Makati City (PH); Benjamin Fernandez, Makati City (PH); Angelito Villanueva, Makati City (PH); Alex D. Ibasco, Makati City (PH); Sherwin Diamante, Makati City (PH); Gilbert Gaw, Makati City (PH)

(73) Assignee: EINNOVATIONS HOLDINGS PTE. LTD., Singapore (SG)

(21) Appl. No.: 14/897,569

(22) PCT Filed: Jun. 13, 2014
(86) PCT No.: PCT/SG2014/000278

§ 371 Date: Dec. 10, 2015

(30) Foreign Application Priority Data
Jun. 13, 2013 (SG) 201304593-5

(51) Int. Cl. G06Q 20/36; G06Q 20/26; G06Q 20/32; G06Q 20/22

(52) U.S. Cl. CPC G06Q 20/363; G06Q 20/227; G06Q 20/26; G06Q 20/3255

(57) ABSTRACT

A system or method for facilitating transaction comprising a host network comprising at least one subscriber account, the at least one subscriber account having: a first electronic wallet for performing specific transactions with a selected institution; a second electronic wallet for performing other types of transactions; and a settlement facility coupled to the host network for performing the transactions, the settlement facility operable to settle and reconcile the transactions, the settlement facility further comprises at least one processor which, on receipt of a request for transaction, determine the type of transaction and debit from the first or second electronic wallet.

### CROSS-REFERENCE TO RELATED APPLICATIONS

This application is a National Stage application of International Application No. PCT/SG2014/000278, filed Jun. 13, 2014, the entire contents of which are incorporated herein by reference.

This application claims priority from Singapore patent application No: 201304593-5; the entire contents of which are incorporated herein by reference.

### FIELD OF THE INVENTION

The present invention relates to a system and method for facilitating transactions. In particular although not exclusively the present invention relates to facilitating government related transactions.

### DISCUSSION OF THE BACKGROUND ART

Most mobile communications systems at present employ two charging paradigms, post-paid and pre-paid. Most post-paid mobile phone services are provided via a contract between the user and a service provider. Under the post-paid paradigm the user is billed at the end of each billing cycle based on their level of usage.

Under the pre-paid paradigms, the user typically purchases the handset along with a set amount of network credit. The user is then free to access the network until they run out of credit. A user may add more credit to the pre-paid account at any time. This is known as “topping up” the account. This top up can be affected by a credit/debit card transaction with the provider or by purchasing a “top-up card” at a retail outlet. The top-up card is stamped with a unique code (often under a scratch-off panel) which can be redeemed on the phone for credit. Credit for a pre-paid mobile phone may have a time limit, for example ninety days from the date the last credit was added. In these cases, customers who do not add more credit before expiration will lose their remaining balance, and the service (and its associated phone number) may be discontinued.

One problem with the use of pre-paid service is the difficulty in recharging credit when the user is outside their service provider's network (e.g. when the user is roaming internationally). In such instances users are unable to purchase recharges cards from their particular service provider. However, as mentioned above, the user has the option to recharge credit by utilising credit or debit cards. Typically, such a recharge facility is provided in the form of a web portal, dial in service via a pre-programmed service number or SMS service. The dial in and SMS recharge can be particularly problematic if the user has insufficient credit to initiate the call or send the SMS. Likewise the web portal requires the user to be able to access the Internet, consequently there may be significant delays between being notified of lack of credit and recharge during which the user is unable to access the network and in some instances unable to receive calls. The delays can be further exacerbated as the user's home network takes some time to register the update in credit values, further delays can occur as the change in credit values is propagated through to the host network.

In addition to the above-mentioned problem, there exists a general need to provide greater convenience in terms of remittance. In particular, in countries such as Philippines, employers of domestic househelp are required to remit monthly membership contributions to the Home Development Mutual Fund (Pag-IBIG Fund) and premium payments to the Philippine Health Insurance Corp. (PhilHealth) and the Social Security System (SSS).

Specifically, there is a need for Domestic Workers (aka Kasambahay) to pay their social protection coverage without the need to go out/travel and spend hours to pay via over-the-counter (OTC) transaction to a Bank or ‘Bayad’ Center (Pay Center). Since Domestic Workers (aka Kasambahay) are often occupied fulfilling their duties, they normally don't have time to go out to pay their bills.

Accordingly there is a need for a system and method that allows for payment to government agencies, private billers and for other payment related use cases where consumers may conduct transactions using a mobile device, the same of which is reloadable through various channels, including existing airtime retailers via mobile, online or via a mobile application, through a direct debit from subscriber's savings account/current account (CASA) bank deposits, and/or credit card to top-up BayadLoad wallet with e-money at par (at face value) equivalent monetary value; and settle through a pre-funded account with a partner bank upon redemption of payment transaction, using either an SMS, USSD or mobile application as bearer channel.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

It would be advantageous to provide a system and method of universal load as a medium for payment for government agencies, private billers and for other payment related use cases supporting a plurality of subscribers, both prepaid and postpaid through a separate mobile wallet reloadable through various channel including, but not limited to, existing airtime retailers via mobile, online or via a mobile application through a direct debit from subscriber's savings account/current account (CASA) bank deposits, and/or credit card to top-up BayadLoad wallet with e-money at par (at face value) equivalent monetary value; settled through a pre-funded account with a partner bank upon redemption of payment transaction; using SMS, USSD or mobile application as bearer channel.

More particularly, the present invention relates to a system and method to pay for government contributions, particularly for members of a social security system.

In accordance with a first aspect of the invention there is a system for facilitating transaction comprising a host network having at least one subscriber account, the at least one subscriber account associated with a first electronic wallet for performing specific transactions with a selected institution and a second electronic wallet for performing other types of transactions; the host network further comprises a settlement facility coupled to the host network for performing the transactions, the settlement facility operable to settle and reconcile the transactions, the settlement facility further comprises at least one processor which, on receipt of a request for transaction, determine the type of transaction and debit from the first or second electronic wallet.

Preferably, the selected institution is a government institution.

Preferably, the specific transactions include one or more of the following:—payment of mandatory contributions for social security; housing; provident and health insurance.

Preferably, the host network is a telecommunications network.

Preferably, the at least one subscriber account is a prepaid mobile subscriber account. Alternatively, the at least one subscriber account is a postpaid mobile subscriber account.

Preferably, the request for transaction is sent via a short messaging service (SMS) text message.

Preferably, credit to the first electronic wallet is not transferable to the second electronic wallet.

Preferably, credits associated with the first electronic wallet do not expire.

Preferably, other types of transactions associated with the second electronic wallet include airtime and talktime reloading associated with a prepaid or postpaid subscriber account.

Preferably, the first electronic wallet is availed to a subscriber having a second electronic wallet via a separate and independent registration process.

Preferably, the system comprises a transaction processor for validating the request for transaction or a part thereof.

In accordance to a second aspect of the invention there is a method for facilitating transaction comprising the following steps:—

a. receiving an electronic request for transaction from a user of a mobile computing device; and

b. determining from the electronic request for transaction the type of transaction; wherein if the type of transaction is a specific transaction associated with a selected institution; then a first electronic wallet associated with the user is utilized for the transaction; otherwise, a second electronic wallet associated with the user is utilized for the transaction.

Preferably, the selected institution is a government institution.

Preferably, the specific transaction include one or more of the following:—payment of mandatory contributions for social security; housing; provident and health insurance.

Preferably, credit to the first electronic wallet is not transferable to the second electronic wallet.

### BRIEF DETAILS OF THE DRAWINGS

In order that this invention may be more readily understood and put into practical effect, reference will now be made to the accompanying drawings, which illustrate preferred embodiments of the invention, and wherein:

FIG. 1 is a schematic diagram illustrating the process steps associated with registering basic subscriber information in accordance with an embodiment of the invention.

FIG. 2 is a schematic diagram illustrating the process steps associated with registering billing account information in accordance with an embodiment of the invention in accordance with an embodiment of the invention.

FIG. 3 is a schematic diagram illustrating the process steps associated with the reload of money via a retailer in accordance with an embodiment of the invention.

FIG. 4 is a schematic diagram illustrating the process steps associated with the subscriber sending a balance inquiry to the system in accordance with an embodiment of the invention.

FIG. 5 is a schematic diagram illustrating the process steps associated with the payment of SS, Pag-IBIG or PhilHealth as employee in accordance with an embodiment of the invention.

FIG. 6 is a schematic diagram illustrating the process steps associated with the payment of SS, Pag-IBIG or PhilHealth by someone other than the employee in accordance with an embodiment of the invention.

FIG. 7 is a schematic diagram illustrating the process steps associated with the subscriber locking the account in accordance with an embodiment of the invention.

FIG. 8 is a schematic diagram illustrating the process steps associated with the subscriber unlocking the account in accordance with an embodiment of the invention.

FIG. 9 is a schematic diagram illustrating the process steps associated with the subscriber requesting for information from the system in accordance with an embodiment of the invention

FIG. 10 is a schematic diagram illustrating the process steps associated with the subscriber requesting help from the system in accordance with an embodiment of the invention; and

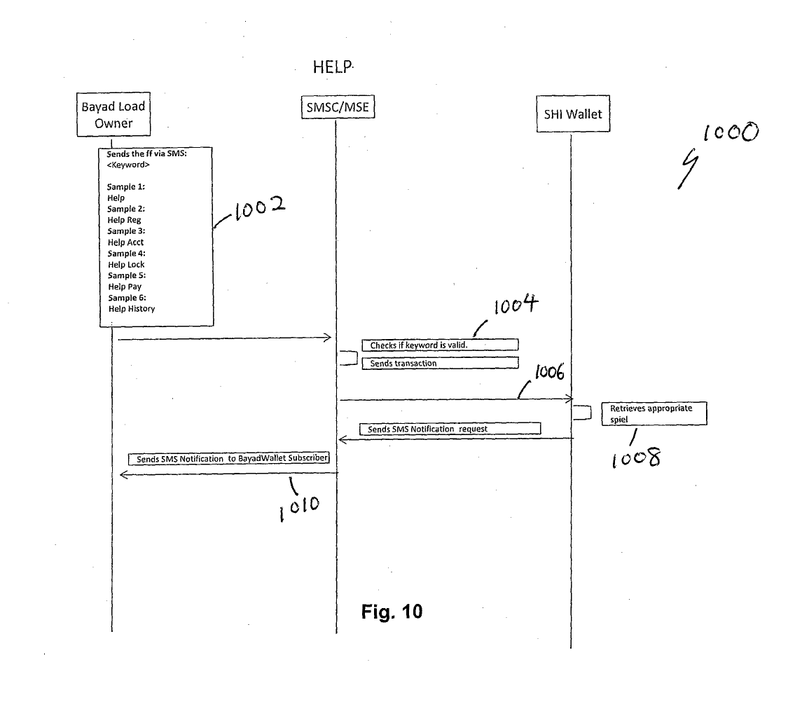

FIG. 11 is a system block diagram of the system in accordance with an embodiment of the invention,

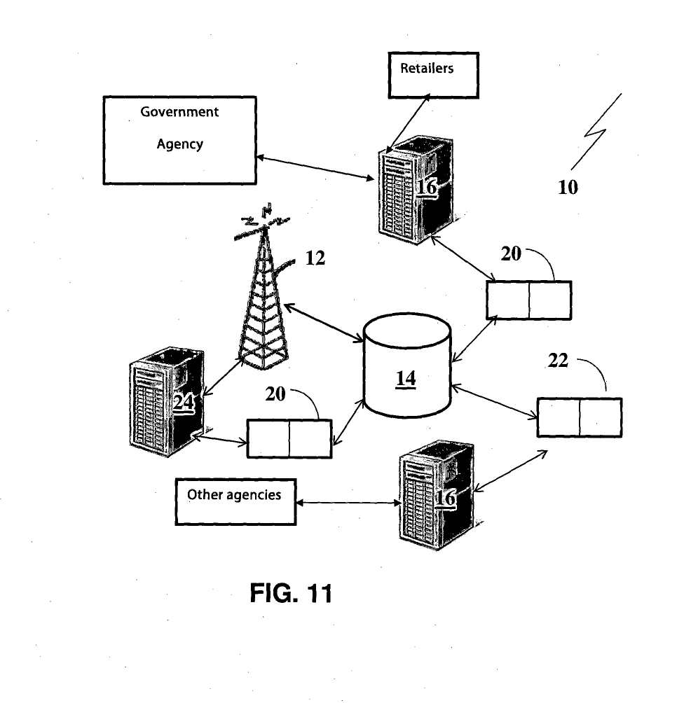

Other arrangements of the invention are possible and, consequently, the accompanying drawings are not to be understood as superseding the generality of the description of the invention.

### DESCRIPTION OF EMBODIMENTS OF THE INVENTION

The system and method described as follows allows prepaid and postpaid subscribers of a communications network to pay for government related contributions. For example, in Philippines, the system allows members of the Social Security System, Philippine Health Insurance Corporation and Home Development Mutual Fund (Pag-IBIG Fund) to pay their contributions/dues to the relevant government agencies. The service aims to provide a convenient, seamless, secure, and accessible alternative payment channel using the subscriber load sourced using a separate and independent electronic wallet other than the conventional electronic airtime wallet used for topping up or ‘recharging’ or talk time credit or other transactions. In particular, the communications provider may be a telecommunications provider. The telecommunications provider can partner with a bank as a settlement entity or facility for credit to individual payee government accounts for the invention to work

This would provide a convenient, seamless, secure, and accessible alternative payment channel, with existing retailers and stores for a telecommunications provider being able to provide this service. The many subscribers that can potentially use this payment facility will benefit accordingly, especially with the lack of additional registration needed. Even subscribers from other telecommunications providers can be availed to this payment service.

For customers of this facility, they will not be required to remember their account numbers everytime, all is required is a one-time registration via SMS to the telecommunications provider. The telecommunications provider can also provide a twenty-four hour balance inquiry system, a twenty-four hour payment window time, as well as an ability to view, download or print collection receipt. The system would be able to determine whether a subscriber has a valid account and would respond accordingly.

The system can also recognise when a single user with matching address is registered with multiple accounts, for example for all three accounts in the Philippines: PhilHealth, SSS or Pag-IBIG Fund. By applying transitivity across the various databases, especially using matching details like addresses and Mobile Identification Number (MIN), the subscriber is recognised as the same person and the system allows the subscriber for all three service account to be linked using the same identification. Such processes can be done by the system in the background without the subscriber being aware of the same, with further prompting triggering actions for the subscriber to take or approve accordingly. With such a system in place, a subscriber can do anonymous purchases on the public transport system or store purchases. The backend settlement and/or reconciliation system goes through the various databases and after removing inconsistent address, the fully matched records become certified identities, allowing them to easier access to the benefits of all the databases. By using this as the basis for better knowing the subscribers, this can also be used for data mining, advertisement matching or even monitoring purposes.

In the description, the terms “first electronic wallet” and “second electronic wallet” are used for the purpose of illustration only for distinguishing the functions of one electronic wallet from another, and hence these terms are not to be construed as limiting in terms of order or priority.

In accordance with an embodiment of the invention there comprises a system 10 for facilitating transaction comprising a host network 12. The host network 12 may be, but is not limited to, a telecommunications provider. The telecommunications provider 12 comprises at least one subscriber account 14. The at least one subscriber account is associated with a first electronic wallet 20 for performing at least first type of transaction with at least one institution. The subscriber account further comprises a second electronic wallet 22 for performing other types of transactions that are mutually exclusive from the first type of transaction.

A settlement facility 16 is coupled to the host network 12 for performing one or both types of transactions. The settlement facility 16 is operable to settle and reconcile the transactions. To achieve the same, the settlement facility 16 comprises at least one processor that, on receipt of a request for transaction, determines the type of transaction and debit/credit from the first or second electronic wallet to effect the transaction. Alternatively, there may be a plurality of settlement facility for settlement of various types of transactions associated with the first and second electronic wallet. Regardless of the configuration, it is to be appreciated that the first type of transaction is to be kept separated and independent from other types of transactions. The first and second electronic wallet may however interact each other for transfer of funds where necessary.

In an embodiment, the settlement facility 16 is a bank coupled and arranged to provide settlement facility for the telecommunications provider 12. The at least one subscriber account 14 may be a postpaid or a prepaid account. The electronic wallets 20, 22 associated with each subscriber are maintained within the telecommunications provider and the first electronic wallet is governed by a specific set of rules which are different from the second electronic wallet. In particular, the first electronic wallet is utilized for the purpose of secure payment, via an alternative payment channel, for mandatory monthly contributions to government agencies. It is to be noted that one of the conditions governing the first electronic wallet is that credit or money placed in the first electronic wallet 20 does not expire and cannot be encashed.

For illustrative purpose, the subscriber may already have a second electronic wallet 22, which he/she utilizes for topping up of talktime or airtime credit or other transactions which could include money transfers, pay bills, reload prepaid accounts, put funds into account, ATM withdrawal, or online shopping.

An example of such a second electronic wallet 22 is Smart Money™, which is the electronic wallet of Smart Communications, Inc. The registrations and procedures surrounding the second electronic wallet or mobile electronic wallet are well detailed and will not be further elaborated.

A transaction processor 24 may be used to validate the request for transaction or a part thereof. An example of such transaction processor 24 is a SMS centre.

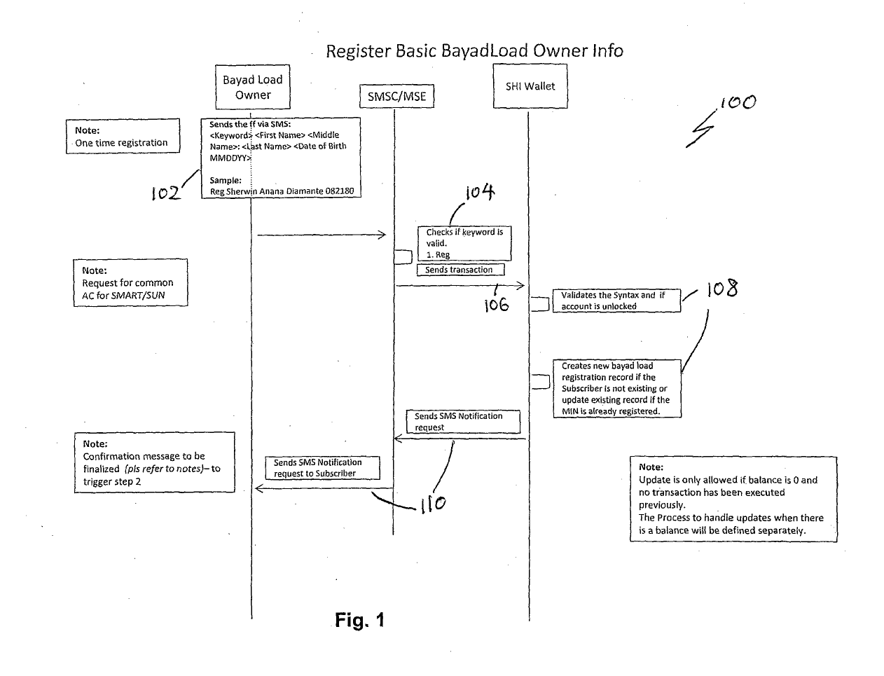

With regards to the first electronic wallet 20, before the user performs the specific transactions associated with the first electronic wallet 20, he/she has to register as a user. The registration process is shown in FIG. 1 and elaborated as follows:—

### Registration (Step 100)

During this process, the basic information and account details of the subscriber is captured. This can be done via SMS, for example, in a <Keyword><First Name><Middle Name>: <Last Name><Date of Birth MMDDYY> format. Thus a user may input “Reg Sherwin Anana Diamante 082180” using SMS into his mobile device and send it off to the SMS centre (step 102).

The SMS centre 24 checks if the <keyword> field “reg” is valid (step 104) and if so sends the registration to the electronic wallet processor (step 106). The electronic wallet processor validates the syntax of the SMS and unlocks the account for registration and creation of the first electronic wallet 20 (hereinafter referred to as Sayadload′ wallet (step 108) which avails data communication to the Bayadload funds for settlement and reconciliation. Once the Bayadload wallet is created, an SMS notification may be sent to the subscriber to notify him of the successful creation (step 110) In the case of a successful notification, the system informs the subscriber that the registration is complete and that the wallet can be loaded (or reloaded) at any of the authorised telecommunication provider's many retailers. For example, the system may reply:
MMMDD HH:MM
Registration Complete! You may now load your BayadLoad wallet from any SMART retailer.
T&C by reloading your reload wallet you agree to the terms and condition in this website: www.bayadload.com
REF#
MMMDD HH:MM
Step 2: Pls register your Billing Account Number by sending
“Acct PIF <Acct#> PHL <Acct#> SSS <Acct#>” for Pagibig, PhilHealth and SSS
Sample 1: Acct PIF 12345678901 PHL PIF 12345678901 SSS PIF 12345678901 or
You can also register 1 account only by sending “Acct PIF <Acct#>”
Sample 2: Acct PIF 12345678901
REF#

In the case of a declined notification, the system would prompt the user to retry based on the errors in the SMS, for example, for invalid syntax, the system may reply:

Example syntax:—
MMMDD HH:MM
Pls retry. Send msg below to 8888
“Reg <firstName><MiddleName><Lastname><Date of Birth MMDDYY>.
Sample: Reg Sherwin Anana Diamante 082180
REF#12345678

In the case of an invalid keyword, the system may reply:
MMMDD HH:MM
Please see list of valid keywords below:
Reg, Acct, Lock, Unlock, Info, Bal, Pay, History,
Help, Help Reg, Help Acct, Help Lock, Help Pay, Help History
REF#<12345678901>

Should the account be unavailable for some reason, the system may reply:
BayadLoad account cannot be edited:
MMMDD HH:MM
BayadLoad account cannot be edited.
REF#<12345678901>
3131 access code

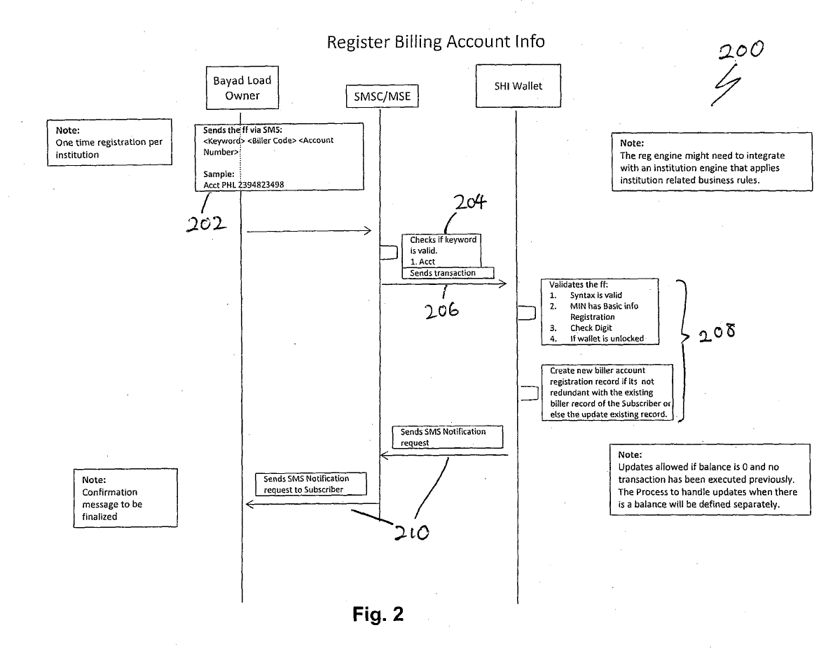

Once the user is registered, now as the owner of the Bayadload account he may be prompted to register the billing account information (200) as illustrated in FIG. 2. The user may do so using the following syntax (step 202) to the SMS centre.

The subscriber can instruct the system to register the billing information by using the syntax <Keyword><Biller Code><Account Number>. Thus a user may send the following via SMS, “Acct PHL 2394823498”. Upon receipt of the SMS, the SMSC performs a check to see if the keyword is valid (step 204), if so, then it is forwarded to the electronic wallet processor for further validation (step 206). The further validation may include checking if the syntax is valid, mobile identification number has been registered, any check digit, and/or if the Bayadload wallet is unlocked. Once determined, a new billing account registration record is created if it is not considered redundant with the existing biller record of the subscriber; or if there is an existing biller record, the existing record is updated (step 208). Once the biller record is created or updated, a SMS notification is sent to the subscriber via the SMS centre (step 210).

The system may then inform the subscriber of the successful notification by sending the following SMS.

Example syntax:—
MMMDD HH:MM
Registration Complete! You may now load your BayadLoad wallet from any SMART retailer.
You have the option to lock this account by sending “Lock <4 Digit PIN>” to 8888. After a successful lock, you can unlock this account anytime by sending “Unlock <4 Digit PIN> to 8888
REF#<12345678901>

Alternatively, the system may decline the notification if the syntax is incorrect:
MMMDD HH:MM
Please send “Acct <Biller Code><Acct#> to 8888.
Valid BillerCodes are “PHL” for PhilHealth, “PIF” for Pag-IBIG fund and “SSS” for SSS. REF#<12345678901>

or if the account is locked:
MMMDD HH:MM
This account is currently locked. Please Unlock first.
REF#12345678

or if the subscriber has no basic registration:
MMMDD HH:MM
MIN is not yet registered for BayadLoad. Pls send the syntax below to 8888
“Reg <firstName><MiddleName><Lastname><Date of Birth MMDDYY><emailAdd—Optional>.
Sample: Reg Sherwin Anana Diamante 082180 regsherwin@email.com
REF#<12345678901>

or if there is an invalid command or keyword:
MMMDD HH:MM
Please see list of valid keywords below:
Reg, Acct, Lock, Unlock, Info, Bal, Pay, History,
Help, Help Reg, Help Acct, Help Lock, Help Pay, Help History
REF#<12345678901>

Should the subscriber wish to update basic information or account details, the registration procedure can be repeated. In some cases, such updates are only allowed if the account has a balance of zero and no transaction has been executed previously. The process to handle updates when there is a balance will be defined separately. Alternatively, the business rule for processing account balance validation may be flexible, i.e. whether the balance may be zero or some other amounts.

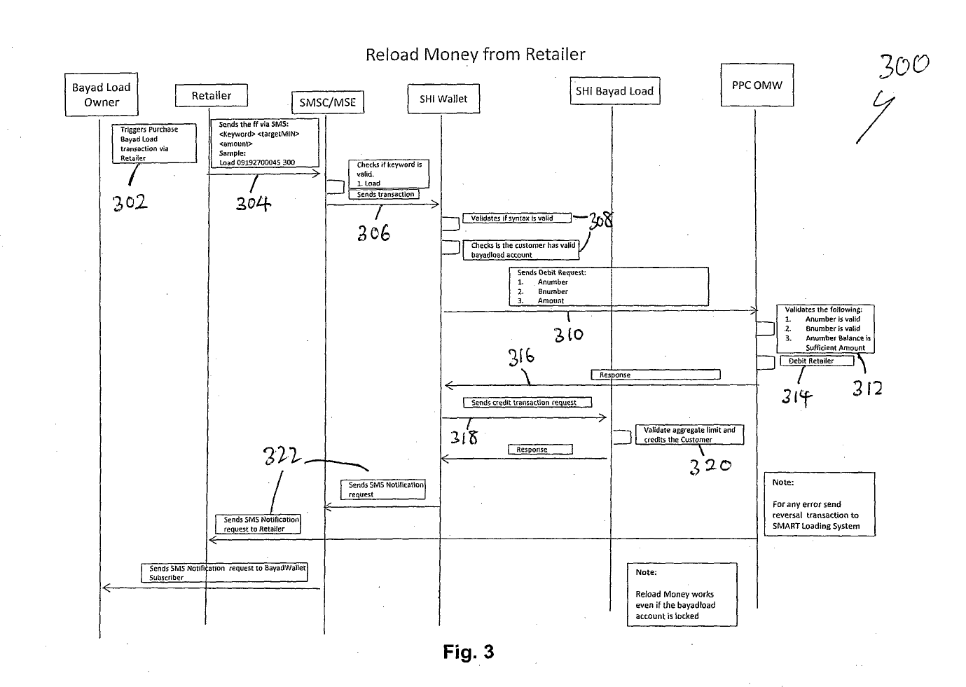

One of the functions that the subscriber can perform is to reload credit or money into his Bayadload account or wallet. The process flow 300 is shown in FIG. 3. A subscriber (owner of Bayadload) may trigger purchase of load via an authorized third party retailer who has an account with the host network (step 302).

The subscriber would have to reload money into the account or Bayadload wallet and one of the methods is to go through a retailer. The amount to be reloaded would depend on the retailer and this can be any amount. As an example, the retailer would send an SMS to the system using the syntax <Keyword><targetMIN><amount>. For example, “Load 09192700045 300” (step 304).

Once forwarded to the SMS centre, the SMS centre checks if the keyword ‘Load’ is a valid keyword. If so, the load request is forwarded to the electronic wallet processor (step 306). The electronic wallet further validates if the syntax is valid and if so, checks if the customer (subscriber) has a valid Bayadload account (step 308). Once checked, the debit request is sent to a fund source PPC OMW for processing (step 310). Fund source PPC OMW is typically used for load airtime of subscribers. The debit request comprises a first identifier corresponding to the retailer's account to be debited (Anumber); a second identifier corresponding to the subscriber account to be credited (Bnumber); and the amount to be debited. Upon verifying the first identifier, second identifier and amount to be debited (step 312), the PPC OMW debits the retailer (step 314). A response is sent from the PPC OMW to the SHI wallet processor (step 316), which then sends a credit transaction request to the Bayadload (step 318). Upon receipt of the credit transaction request, the Bayadload validate the aggregate limit and credits the customer (step 320).

The system would then notify both the retailer and subscriber accordingly if the transaction was successful (step 322). For example, the system would send the following to the retailer:

Example syntax:—
MMMDD HH:MM
You have successfully loaded P200 to Sherwin's BayadLoad Wallet via 09192700045.
New Load wallet balance is P195.
REF#<123456789>

And send the following to the subscriber:
MMMDD HH:MM
P200 was successfully loaded to your BayadLoad Wallet.
New BayadLoad wallet balance is P400.
Before paying please remember to load 12% more on top of the payment premium amount to avoid inconvenience.
REF#<123456789>

In the case of a declined notification, the system can send the following message, depending on the nature of the message. For insufficient balance, the system would send:
MMMDD HH:MM
Your load wallet account has no sufficient balance to fulfil this transaction. Your available balance is only P90.
REF#<12345678901>

For maximum aggregate limit reached, the system may send:
MMMDD HH:MM
Sorry the maximum target limit of target BayadLoad wallet has been
reached. Your available balance is only P10,000.
REF#<12345678901>

For invalid syntax, the system may send:
MMMDD HH:MM
Please send “Pay <MIN><billerCode><amount>” to 8888.
Valid BillerCodes are “PHL” for PhilHealth, “PIF” for Pag-IBIG fund and “SSS” for SSS.
REF#<12345678901>

If the subscriber is not yet registered with the system, the following message can be sent:
MMMDD HH:MM
MIN is not yet registered for BayadLoad. Pls send the syntax below to 8888
“Reg <firstName><MiddleName><Lastname><Date of Birth MMDDYY><emailAdd—Optional>.
Sample: Reg Sherwin Anana Diamante 082180 regsherwin@email.com
REF#<12345678901>

In the case of an invalid keyword, the following message can be sent:
MMMDD HH:MM
Please see list of valid keywords below:
Reg, Acct, Lock, Unlock, Info, Bal, Pay, History,
Help, Help Reg, Help Acct, Help Lock, Help Pay, Help History
REF#<12345678901>

As an alternative, the fund source PPC OMW may be replaced by another fund source dedicated for the purpose of providing funds to complete the Bayadload related transactions.

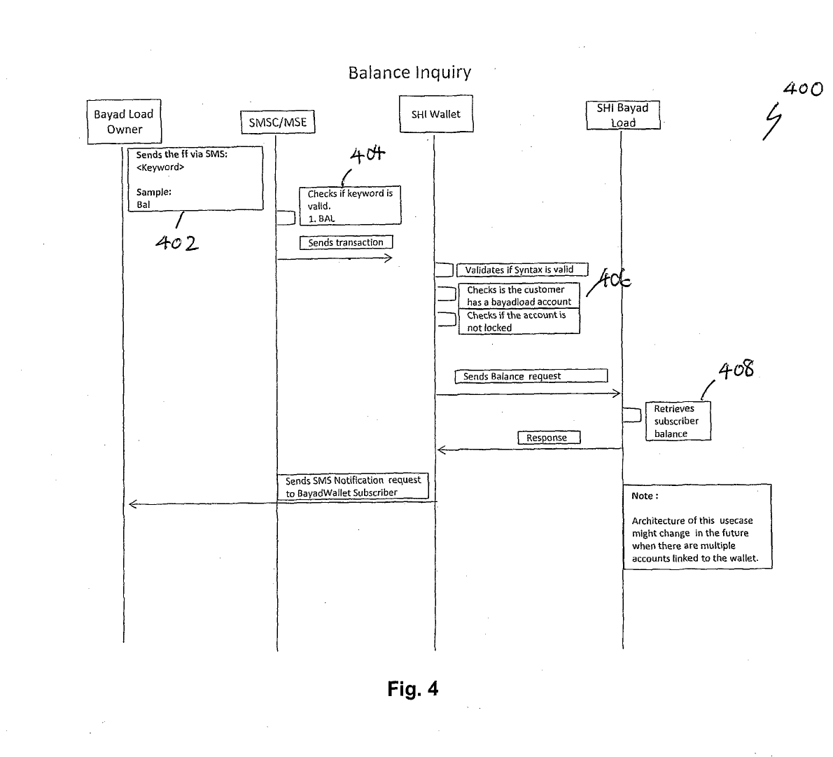

### Balance Enquiry (FIG. 4)

Should the subscriber wish to check the balance of his Bayadload account 400, it can be done via SMS by a keyword, <Keyword>. For example, by sending a keyword “Bal” to the SMSC (step 402), the system would check if the keyword is valid (step 404). Upon verification, the request for enquiry of balance is then sent to the first electronic wallet 20 which validates the syntax and performs checks on whether the Bayadload account is unlocked, whether the account is present (step 406). Upon verification, the subscriber's balance is retrieved from the Bayadload database (step 408) and reply is sent in the case of a successful notification:

Example syntax:—
MMMDD HH:MM
The available balance of your BayadLoad wallet is P200.
Before paying please remember to load 12% more on top of the payment premium amount to avoid inconvenience.
REF#<123456789>

And the following for a declined notification:
BayadLoad Account is locked:
MMMDD HH:MM
This is currently locked. Please Unlock first.
REF#12345678

And if the subscriber is not registered with the system, the following message may be sent:
MMMDD HH:MM
MIN is not yet registered for BayadLoad. Pls send the syntax below to 8888
“Reg <firstName><MiddleName><Lastname><Date of Birth MMDDYY><emailAdd—Optional>.
Sample: Reg Sherwin Anana Diamante 082180 regsherwin@email.com
REF#<12345678901>

As usual, in the case of an invalid keyword, the system sends the following message:
MMMDD HH:MM
Please see list of valid keywords below:
Reg, Acct, Lock, Unlock, Info, Bal, Pay, History,
Help, Help Reg, Help Acct, Help Lock, Help Pay, Help History
REF#<12345678901>

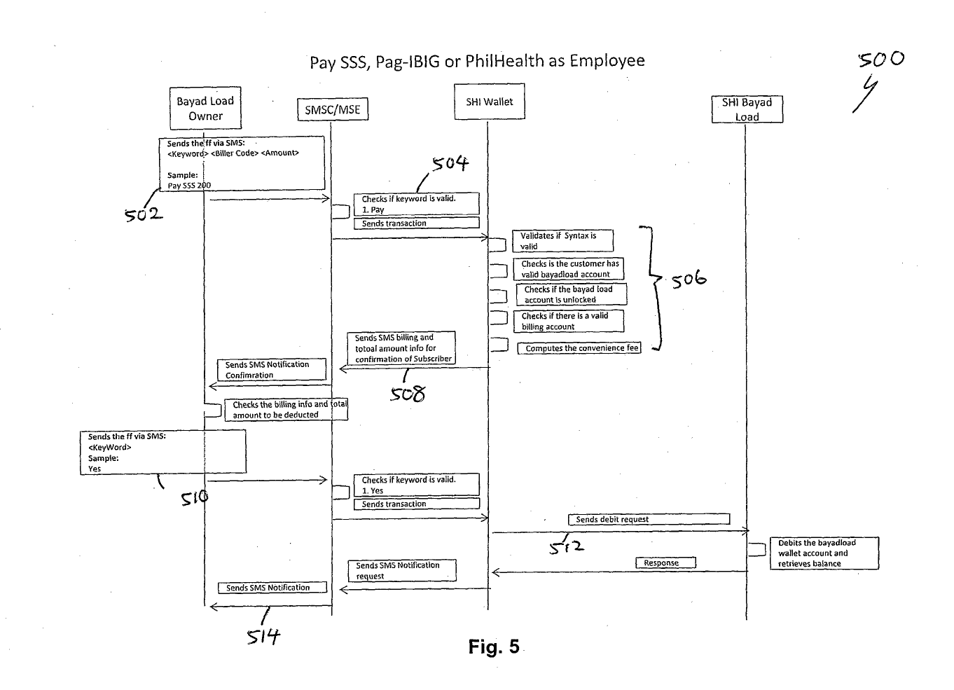

### Payment to Government Agencies (FIG. 5)

As an employee, the subscriber may wish to pay either one of the healthcare system, insurance, or retirement fund (500). This can be achieved by sending an SMS to the system using the syntax <Keyword><Biller Code><Amount>, example “Pay SSS 200” (step 502). As with previous transactions, the SMS is sent to the SMS centre which then checks if the keyword ‘Pay’ is valid (step 504) and if so, send the request to the electronic wallet 20 (SHI wallet) for further processing. The wallet validates if the syntax is valid; whether there is a valid Bayadload account and whether the account is unlocked. Further the Bayadload account checks if there is a valid billing account and computes any convenience fee due (step 506). Once the same is done, a SMS notification is sent to the subscriber with respect to the total amount for confirmation by the subscriber (step 508). If the subscriber confirms by replying with a correct keyword (for example ‘Yes’—see step 510), then the SMS centre sends the transaction to the electronic wallet for processing. The electronic wallet then sends the debit request to the Bayadload database for debit of the necessary funds (step 512) and notify the subscriber accordingly (step 514) upon successful debit from the bayadload wallet account.

In the case of a successful notification in step 514, an example of the syntax is as follows:
MMMDD HH:MM
You have successfully paid P200 to SSS account 123456789 of Sherwin Diamante. P24 convenience fee was deducted to your BayadLoad Wallet.
Your new BayadLoad wallet balance is P76.
REF#<123456789>

At the early stage of the system, mMultiple payments using a single SMS may not be implementable at a later stage by scaling up the various systems needed.

In the case of a declined notification, the system informs the subscriber accordingly: For a locked account:
MMMDD HH:MM
This is currently locked. Please Unlock first.
REF#12345678

For an insufficient balance:
MMMDD HH:MM
Your BayadLoad wallet account has no sufficient balance.
Please remember to load 12% more on top of the payment premium amount to avoid inconvenience.
REF#<12345678901>

For an invalid syntax:
MMMDD HH:MM
Please send “Pay <billerCode><amount>” to 8888.
Valid BillerCodes are PHL for PhilHealth, PIF for Pag-IBIG fund and SSS for SSS.
REF#<12345678901>

And if the subscriber is not registered with the system:
MMMDD HH:MM
MIN is not yet registered for BayadLoad. Pls send the syntax below to 8888
“Reg <firstName><MiddleName><Lastname><Date of Birth MMDDYY><emailAdd—Optional>.
Sample: Reg Sherwin Anana Diamante 082180 regsherwin@email.com
REF#<12345678901>

As usual, in the case of an invalid keyword, the system sends the following message:
MMMDD HH:MM
Please see list of valid keywords below:
Reg, Acct, Lock, Unlock, Info, Bal, Pay, History,
Help, Help Reg, Help Acct, Help Lock, Help Pay, Help History
REF#<12345678901>

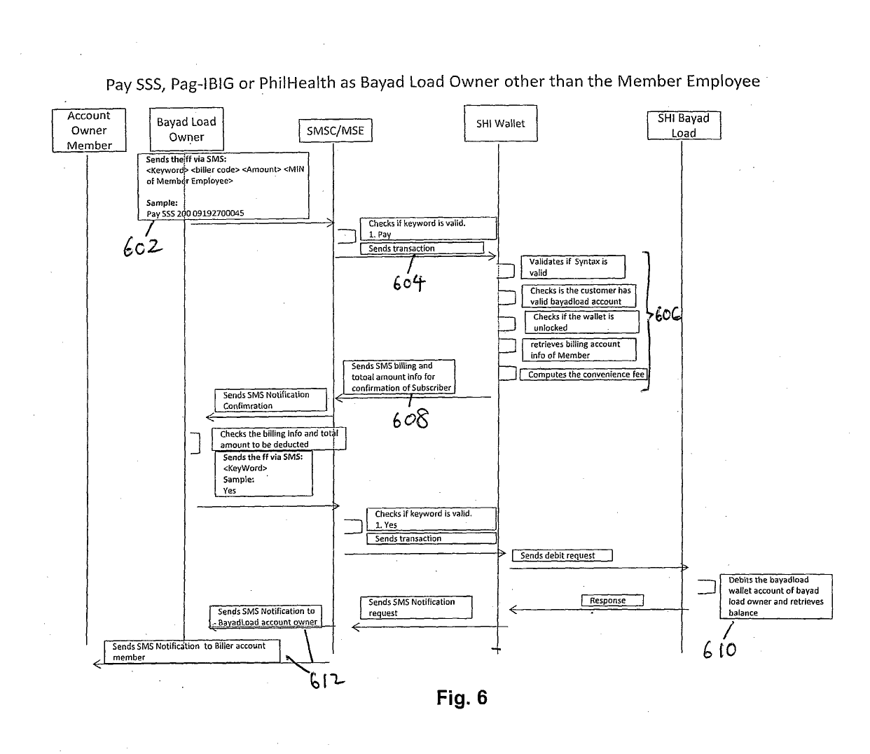

### Third Party Payment (FIG. 6)

Should someone else (a third party) other than the subscriber wishes to pay into the subscriber's Bayadload account, that third party would have to register with the system first (if he does not have an existing account) using the process of FIG. 1 and create a necessary Bayadload wallet. Then, the following example syntax can be used:

<Keyword><biller code><Amount><MIN of Member Employee>. For example, “Pay SSS 200 09192700045” (step 602). As with previous described transactions, the request may be sent as a SMS to the SMS centre for processing. The SMS centre checks if the keyword ‘Pay’ is valid and if so sends the transaction to the Bayadload wallet for further processing (step 604). The first electronic wallet performs validation to determine if the syntax is valid; the customer has a valid Bayadload account; whether the Bayadload wallet is unlocked and retrieves the billing account information of the subscriber. The Bayadload wallet also computes the convenience fee (step 606).

The billing and total amount to be billed is sent to confirmation by the third party (step 608). Once approved, for example the third party sends a keyword “Yes” to the SMS centre, the SMS centre checks if the keyword is valid and if so, sends the debit request to the Bayadload database for the necessary fund transfer. The Bayadload wallet account of the third party is then debited (step 610) and notifications are sent accordingly (step 612). Example syntax as follows:—

In the case of a successful notification, the system responds to the employee and payor accordingly as follows:

To Employee:
MMMDD HH:MM
Lito Villanueva paid P200 to your SSS with acct#123456789.
REF#<123456789>

To Payor:
MMMDD HH:MM
You have successfully paid P200 to SSS account 123456789 of Sherwin Diamante. P24 convenience fee was deducted to your BayadLoad Wallet.
Your new BayadLoad wallet balance is P76.
REF#<123456789>

In the case of a declined notification, the system informs the subscriber accordingly: For a locked account:
MMMDD HH:MM
This is currently locked. Please Unlock first.
REF#12345678

For an insufficient balance:
MMMDD HH:MM
Your BayadLoad wallet account has no sufficient balance.
Please remember to load 12% more on top of the payment premium amount to avoid inconvenience.
REF#<12345678901>

For an invalid syntax:
MMMDD HH:MM
Please send “Pay <billerCode><amount>” to 8888.
Valid BillerCodes are PHL for PhilHealth, PIF for Pag-IBIG fund and SSS for SSS.
REF#<12345678901>

And if the subscriber is not registered with the system:
MMMDD HH:MM
MIN is not yet registered for BayadLoad. Pls send the syntax below to 8888
“Reg <firstName><MiddleName><Lastname><Date of Birth MMDDYY><emailAdd—Optional>.
Sample: Reg Sherwin Anana Diamante 082180 regsherwin@email.com
REF#<12345678901>

As usual, in the case of an invalid keyword, the system sends the following message:
MMMDD HH:MM
Please see list of valid keywords below:
Reg, Acct, Lock, Unlock, Info, Bal, Pay, History,
Help, Help Reg, Help Acct, Help Lock, Help Pay, Help History
REF#<12345678901>

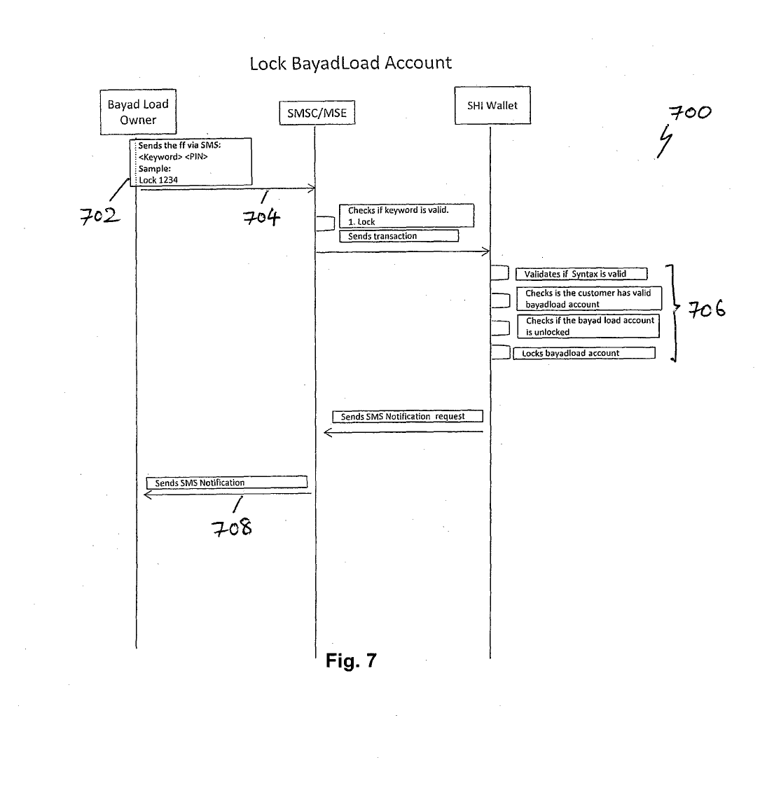

### Lock Bayadload Account (FIG. 7)

The subscriber is also able to lock the account within the system by using SMS, using the syntax <Keyword><PIN>, for example “Lock 1234” (step 702). The SMS is sent to the SMS centre for processing (step 704), the SMS centre in turn checks if the keyword “Lock” is valid and if so, sends the lock request transaction to the Bayadload wallet for further processing and validation. The validation process may include checking if the syntax is valid, whether the customer has a valid Bayadload account; whether the Bayadload account is unlocked. Once these checks are performed, the Bayadload wallet locks the Bayadload account (step 706). Notifications in the form of SMS or otherwise are sent to the subscriber (step 708).

If the notification is successful, the system replies to the subscriber:
MMMDD HH:MM
Your account is locked. Please send “Unlock <PIN>” to unlock this account
REF#<123456789>

By locking the account, the subscriber is no longer able to pay or find out the balance of the account, or even edit details of the account. Instead, the subscriber can only reload the account through a retailer, or accept payment from a third party payor to the account. There may be also instances where the subscriber or the system can specify that the account be locked after a certain number of transactions. The system may send the following message:
MMMDD HH:MM
Your account is locked. Please send “Unlock <PIN>” to unlock this account
REF#<123456789>

In the case of a declined notification, the system informs the subscriber accordingly: For a locked account:
MMMDD HH:MM
This is currently locked. Please Unlock first.
REF#12345678

For an insufficient balance:
MMMDD HH:MM
Your BayadLoad wallet account has no sufficient balance.
Please remember to load 12% more on top of the payment premium amount to avoid inconvenience.
REF#<12345678901>

For an invalid syntax:
MMMDD HH:MM
Please send “Pay <billerCode><amount>” to 8888.
Valid BillerCodes are PHL for PhilHealth, PIF for Pag-IBIG fund and SSS for SSS.
REF#<12345678901>

And if the subscriber is not registered with the system:
MMMDD HH:MM
MIN is not yet registered for BayadLoad. Pls send the syntax below to 8888
“Reg <firstName><MiddleName><Lastname><Date of Birth MMDDYY><emailAdd—Optional>.
Sample: Reg Sherwin Anana Diamante 082180 regsherwin@email.com
REF#<12345678901>

As usual, in the case of an invalid keyword, the system sends the following message:
MMMDD HH:MM
Please see list of valid keywords below:
Reg, Acct, Lock, Unlock, Info, Bal, Pay, History,
Help, Help Reg, Help Acct, Help Lock, Help Pay, Help History
REF#<12345678901>

Should the account be already locked, the system sends:
MMMDD HH:MM
Your account is already locked.
REF#<12345678901>

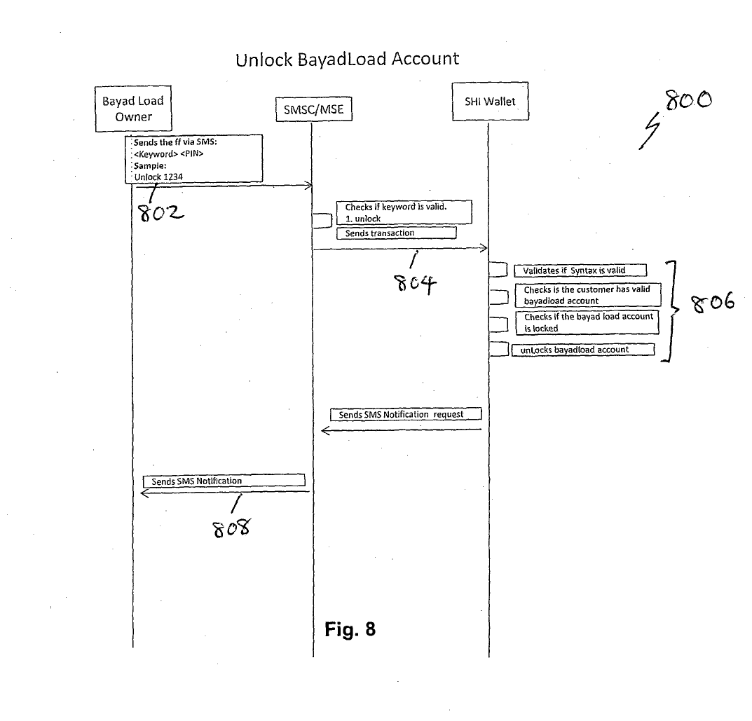

### Unlock Bayadload Account (FIG. 8)

The subscriber can unlock a locked Bayadload account to continue using it (800). This can be done using the same syntax <Keyword><PIN>, for example “Unlock 1234” (step 802). Upon receipt of the unlock request, the SMSC checks if the keyword is valid and if so sends the transaction for further processing by the electronic wallet 20 (step 804). The electronic wallet 20 is operable to check the syntax, whether the customer indeed has a valid bayadload account, and if the account is indeed locked and if so, unlocks the account (806). Notifications will then be sent (808).

If this occurs during a transaction where the account is locked, the system may send:
MMMDD HH:MM
Your account is locked. Please send “Unlock <PIN>” to unlock this account
REF#<123456789>

In the case of a declined notification, the system informs the subscriber accordingly:

For an account that is locked:
MMMDD HH:MM
This is currently locked. Please Unlock first.
REF#12345678

For an invalid syntax:
MMMDD HH:MM
Please send “Lock <4 digit PIN> to 8888”.
REF#<12345678901>

And if the subscriber is not registered with the system:
MMMDD HH:MM
MIN is not yet registered for BayadLoad. Pls send the syntax below to 8888
“Reg <firstName><MiddleName><Lastname><Date of Birth MMDDYY><emailAdd—Optional>.
Sample: Reg Sherwin Anana Diamante 082180 regsherwin@email.com
REF#<12345678901>

As usual, in the case of an invalid keyword, the system sends the following message:
MMMDD HH:MM
Please see list of valid keywords below:
Reg, Acct, Lock, Unlock, Info, Bal, Pay, History,
Help, Help Reg, Help Acct, Help Lock, Help Pay, Help History
REF#<12345678901>

Should the account be already unlocked, the system sends:
MMMDD HH:MM
Your account is already unlocked.
REF#<12345678901>

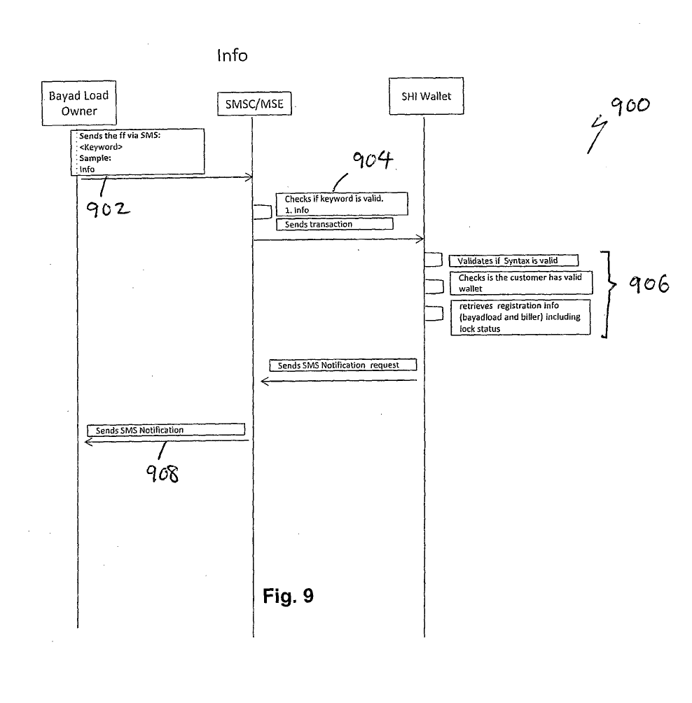

As shown in FIG. 9, a subscriber may query for information relating to his registration and billing details (900). A keyword, for example “Info” is sent as a SMS to the SMS centre (step 902). The SMS centre checks if the keyword is valid (step 904) and if so, sends a transaction to the Bayadload wallet. The Bayadload wallet then checks if the syntax is valid; if the customer (subscriber) has a valid wallet, and if so, retrieves the necessary registration and billing details (step 906). Upon successful completion, notifications may then be sent to the subscriber in a form of SMS (step 908).

In case the Bayadload owner (i.e. subscriber) requires help in any of the aforementioned transactions (1000), he or she may send a Keyword with “Help” for a general reply or “Help Reg” for Help in completing the registration process, for example (step 1002) to the SMS centre.

Upon receipt of the “Help” transaction, the SMS centre checks if the Keyword is valid (step 1004) and if so, sends the Help transaction to the Bayadload electronic wallet 20 for further checks (step 1006). Upon receipt of the Help transaction, the Bayadload electronic wallet retrieves the necessary information (step 1008) and then sends a SMS notification (step 1010) with the desired response or a link to the response.

An example of the one or more settlement facilities 16 utilized in the embodiments may be as described in PCT publication WO 2010/062266 A1 titled “Credit Provision System and Method”. In particular, the described credit facility 16 is able to provide credit to one or more subscribers. In addition, the settlement facility 16 possesses the capabilities to process and settle transactions involving at least three parties: the host (home) network 12; a retailer of the host network; and the subscriber (prepaid or postpaid) of the host network. Further, the credit facility 16 allows for different currencies to be transacted via a base currency denominator.

In another embodiment of the invention, the first electronic wallet 20, in addition to facilitating government related transactions, is also adapted for general non-telecommunications provider network related transactions that include gaming and hospital insurance, provider of utilities (e.g. electrical power), Digital TV or hub subscriptions, gaming etc.

The second electronic wallet 22 is used for transactions relating to loading/reloading of airtime; SMS credits; call; voice and other data services of the subscribers of the telecommunications provider.

In another embodiment, a subscriber may go to the nearest retailer to top-up his first electronic (i.e. BayadLoad) wallet. The retailer shall access his user interface menu using the same retailer SIM (which had been pre-registered) and key in the target identifier (e.g. mobile MSISDN) of the target Bayadload account and the amount to be loaded. It shall then validate if the target account has an active BayadLoad wallet before processing the request. Both retailer and subscriber shall receive a notification message confirming the successful processing of request.

It is to be understood that the above embodiments have been provided only by way of exemplification of this invention, and that further modifications and improvements thereto, as would be apparent to persons skilled in the relevant art, are deemed to fall within the broad scope and ambit of the present invention described herein. In particular:—
While the described embodiments relate to the sending of requests for various transactions using SMS; the sending of requests may be achieved via other means such as Unstructured Supplementary Service Data (USSD) message; dedicated client software installed on a user's smartphone etc.
Although the embodiments have described the first electronic wallet (i.e. the Bayadload wallet 20 as having two separate components (see SHI Wallet and SHI Bayadload), the same may be integrated as one single platform to verify and process the transaction, and link the same to settlement facility 16.
All transactions to be settled by the settlement facility 16 may be collated and sent via a batch process daily. The settlement facility 16 then triggers the transfer of funds from the bank account of the host network to the biller account of the Bayadload account holder. The batch process may be via a secure network protocol for secure file transfer over secure shell such as (but not limited to) the SSH File Transfer Protocol (SFTP).
The electronic wallets 20, 22 may be interface with commercially available electronic wallets (non-host network electronic wallet) to provide greater suite of services to a subscriber of the host network 12.
The retailers for Bayadload top-ups, reloading may be downstream of a chain of providers such as regional distributor or provincial distributor.

1. A system for facilitating transaction comprising
a host network comprising a subscriber account, the subscriber account comprising:
a first electronic wallet that performs specific transactions with a selected institution via a secure payment channel; and
a second electronic wallet that performs other types of transactions; and
a settlement facility coupled to the host network for performing the specific transactions and the other transactions, the settlement facility operable to settle and reconcile the specific transactions and the other transactions, the settlement facility further comprises a processor which, on receipt of a request for transaction, determines a determine the type of transaction and debit from the first or second electronic wallet;
wherein credits associated with the first electronic wallet do not expire and cannot be encashed.

2. The system for facilitating transaction according to claim 1, wherein the selected institution is a government institution or government related institution.

3. The system for facilitating transaction according to claim 2, wherein the specific transactions comprise include one or more of the following group consisting of: payment of mandatory contributions for social security; housing; provident and health insurance.

4. The system for facilitating transaction according to claim 1, wherein the host network is a telecommunications network.

5. The system for facilitating transaction according to claim 1, wherein the subscriber account is a prepaid mobile subscriber account.

6. The system for facilitating transaction according to claim 1, wherein the subscriber account is a postpaid mobile subscriber account.

7. The system for facilitating transaction according to claim 4, wherein the request for transaction is sent via a short messaging service (SMS) text message.

8. The system for facilitating transaction according to claim 1, wherein credit to the first electronic wallet is not transferable to the second electronic wallet.

9. The system for facilitating transaction according to claim 1, wherein the other types of transactions associated with the second electronic wallet comprise airtime reloading associated with a prepaid or postpaid subscriber account.

10. The system for facilitating transaction according to claim 1, wherein the first electronic wallet is availed to a subscriber having a second electronic wallet via a separate and independent registration process.

11. A method for facilitating transaction comprising:
receiving an electronic request for transaction from a user of a mobile computing device; and
determining from the electronic request for transaction a type of transaction; wherein if the type of transaction is a specific transaction associated with a selected institution; then a first electronic wallet associated with the user is utilized for the transaction via a secure payment channel; otherwise, a second electronic wallet associated with the user is utilized for the transaction; wherein credits associated with the first electronic wallet do not expire and cannot be encashed.

12. The method for facilitating transaction according to claim 11, wherein the selected institution is a government institution.

13. The method for facilitating transaction according to claim 12, wherein the specific transaction comprises one or more of the following group consisting of: payment of mandatory contributions for social security; housing; provident and health insurance.

14. The method for facilitating transaction according to claim 11, wherein credit to the first electronic wallet is not transferable to the second electronic wallet.

15. The system for facilitating transaction according to claim 5, wherein the request for transaction is sent via a short messaging service (SMS) text message.
